(19) United States
(12) Patent Application Publication
(10) Pub. No.: US 2007/0052960 A1
(43) Pub. Date: Mar. 8, 2007

(54) Reference image forming apparatus, pattern inspection apparatus, and reference image forming method, and reticle

(75) Inventor: Nobuyuki Harabe, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Advanced Mask Inspection Technology Inc., Kawasaki-shi (JP)

(21) Appl. No.: 11/298,720

(22) Filed: Dec. 12, 2005

(30) Foreign Application Priority Data
Sep. 8, 2005 (JP) 2005-260109

(51) Int. Cl. G01B 11/00

(52) U.S. Cl. 356/394

(57) ABSTRACT

A method and apparatus for forming an appropriate reference image in inspection of a pattern of an object to be inspected depending on characteristics of the pattern are disclosed. A reference image forming apparatus includes an optical image acquisition unit which acquires an optical image of an object to be inspected, a conversion parameter determining unit which uses feature data based on the characteristic of the pattern of the image of the object to be inspected to calculate a conversion parameter from the optical image and design data of the object to be inspected, and a reference image creation unit which performs arithmetic processing to the conversion parameter and the design data to form a reference image.

### CROSS-REFERENCE TO RELATED APPLICATION

This application is based upon and claims the benefit of priority from prior Japanese Patent Application No. 2005-260109 filed on Sep. 8, 2005 in Japan, the entire contents of which are incorporated herein by reference.

### BACKGROUND OF THE INVENTION

### Field of the Invention

The present invention relates to pattern inspection for an object to be inspected such as a reticle, a reference image used in the pattern inspection, and a manufactured reticle. In particular, the present invention relates to pattern inspection for an object to be inspected used in manufacturing a semiconductor device or a liquid crystal display panel, a reference image used in the pattern inspection, and a manufactured reticle.

In processes of manufacturing a large-scale integrated circuit (LSI), a reduced projection exposure device (stepper) for transferring a circuit pattern uses a reticle (photomask) obtained by enlarging a circuit pattern 4 to 5 times as an original. Demands for completeness of the reticle, i.e., pattern precision, non-defectiveness, and the like are considerably increasing every year. In recent years, pattern transfer is performed at an approximate limiting resolution because of ultra-micropatterning and high-density integration, and a high-precision reticle is one of keys for manufacturing a device. Of these keys, improvement in performance of a pattern inspecting device for detecting a defect on an ultra-micropattern is necessary for improving short-term development and manufacturing yield of an advanced semiconductor device. In pattern inspection of a high-precision reticle, a reference image similar to an optical image drawn on a reticle is formed from design data of the reticle, and the optical image and the reference image are compared with each other to detect a defect of the pattern of the reticle. However, the reference image must be made more similar to the optical image. Therefore, a method is known in which an inspection precision is set for every pattern of a reticle to perform pattern inspection (see Japanese Patent Application, Publication No. 2004-191957)

### BRIEF SUMMARY OF THE INVENTION

(1) The present invention has an object to appropriately form a reference image in pattern inspection of an object to be inspected depending on characteristics of the pattern.

(2) The present invention has another object to obtain a reference image forming apparatus which can obtain a fine pattern, a pattern inspecting apparatus, a reference image forming method, or a reticle.

A reference image forming apparatus according to an embodiment of the present invention includes: an optical image acquisition unit which acquires an optical image of an object to be inspected; a conversion parameter determining unit which uses feature data based on pattern features of the image of the object to be inspected to calculate a conversion parameter from the optical image and design data of the object to be inspected; and a reference image creation unit which performs arithmetic processing to the conversion parameter and the design data to form a reference image.

A pattern inspection apparatus according to an embodiment of the present invention includes: an optical image acquisition unit which acquires an optical image of an object to be inspected; a conversion parameter determining unit which uses feature data based on pattern features of the image of the object to be inspected to calculate a conversion parameter from the optical image and design data of the object to be inspected; a reference image creation unit which performs arithmetic processing to the conversion parameter and the design data to form a reference image; and a comparator unit which compares the optical image with the reference image.

A reference image forming method, which forms a reference image similar to an optical image of an object to be inspected from design data of the object to be inspected, according to an embodiment of the present invention includes: using feature data representing pattern features in an image to calculate a conversion parameter from the optical image and the design data; and performing arithmetic processing to the conversion parameter and the design data to form a reference image.

A reticle according to an embodiment of the present invention undergoes a pattern inspection which uses feature data representing pattern features of an image of the reticle to calculate a conversion parameter from an optical image and design data, performs arithmetic processing to the conversion parameter and the design data to form a reference image, and compares the optical image with the reference image.

### BRIEF DESCRIPTION OF THE SEVERAL VIEWS OF THE DRAWINGS

FIG. 1 is a block diagram of a reference image forming apparatus;

FIG. 2 is a conceptual diagram showing the configuration of a pattern inspection apparatus;

FIG. 3 is a diagram for explaining scanning of a pattern of a reticle;

FIG. 4 is a flow chart for forming a reference image;

FIGS. 5A and 5B are diagrams for explaining feature data showing characteristics of a specific pattern; and

FIGS. 6A and 6B are diagrams for explaining feature data showing characteristics of another specific pattern.

### EXPLANATION OF REFERENCE NUMERALS

### Detailed Description of the Preferred Embodiments

A reference image forming apparatus, a pattern inspection apparatus, a reference image forming method, a pattern inspecting method, and a reticle according to an embodiment of the present invention will be described below.

(Pattern Inspection Apparatus)

A pattern inspection apparatus is to inspect a pattern formed on an object to be inspected such as a reticle to check whether the pattern is formed in a predetermined form. The pattern inspection apparatus includes an optical image acquisition unit and a data processing unit. The optical image acquisition unit reads a pattern drawn on an object to be inspected to obtain an optical image. The data processing unit is to perform control of the pattern inspection apparatus, e.g., the optical image acquisition unit, and data processing. The data processing unit has a conversion parameter determining unit, which determines a conversion parameter to form a reference image, and a reference image creation unit. The pattern inspection apparatus compares the obtained optical image with the reference image to inspect a defect or the like of an optical image drawn on an object to be inspected.

In this case, the reference image is an image formed from design data of the object to be inspected such that the reference image is similar to the optical image. The design data is data for design serving as a base for drawing an image on the object to be inspected. Although a reticle will be described below as an object to be inspected, as the object to be inspected, any object on which a pattern is formed may be used, and a mask or a wafer may also be used.

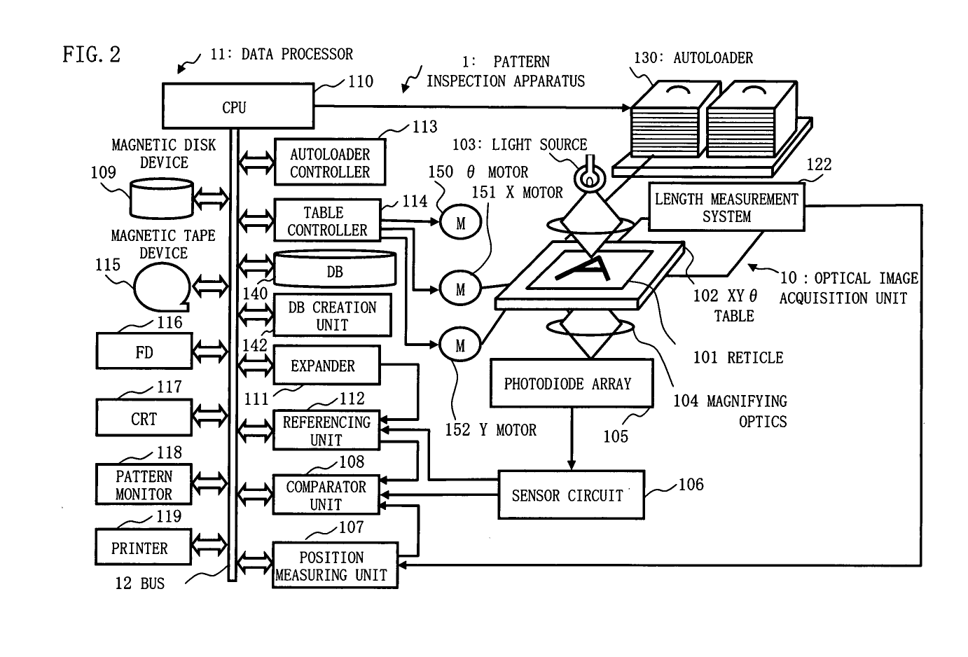

A pattern inspection apparatus 1, for example, as shown in FIG. 2, includes an optical image acquisition unit 10 and a data processing unit 11. The optical image acquisition unit 10 includes, as needed, an autoloader 130, a light source 103, XYθ table 102 on which a reticle 101 is placed, a θ motor 150, an X motor 151, a Y motor 152, a laser-assisted length measurement system 122, a magnifying optics system 104, a photodiode array 105, a sensor circuit 106, and the like. The data processing unit 11 includes, as needed, a central processing unit 110, a bus 12, an autoloader controller 113 which controls the autoloader 130 connected to the bus 12, a table controller 114 which controls the XYθ table 102, a database 140, a database creation unit 142, a expander 111, a referencing unit 112 which receives pattern data of design data from the expander 111 and receives an optical image from the sensor circuit 106, a comparator unit 108 which receives the optical image from the sensor circuit 106 and receives a reference image from the referencing unit 112, a position measurement unit 107 which receives a position signal of the table 102 from the laser-assisted length measurement system 122, a magnetic disk device 109, a magnetic tape device 115, a FD 116, a CRT 117, a pattern monitor 118, a printer 119, and the like. The pattern inspection apparatus 1 is constituted by an electronic circuit, a program, or a combination thereof.

(Reference Image Forming Apparatus)

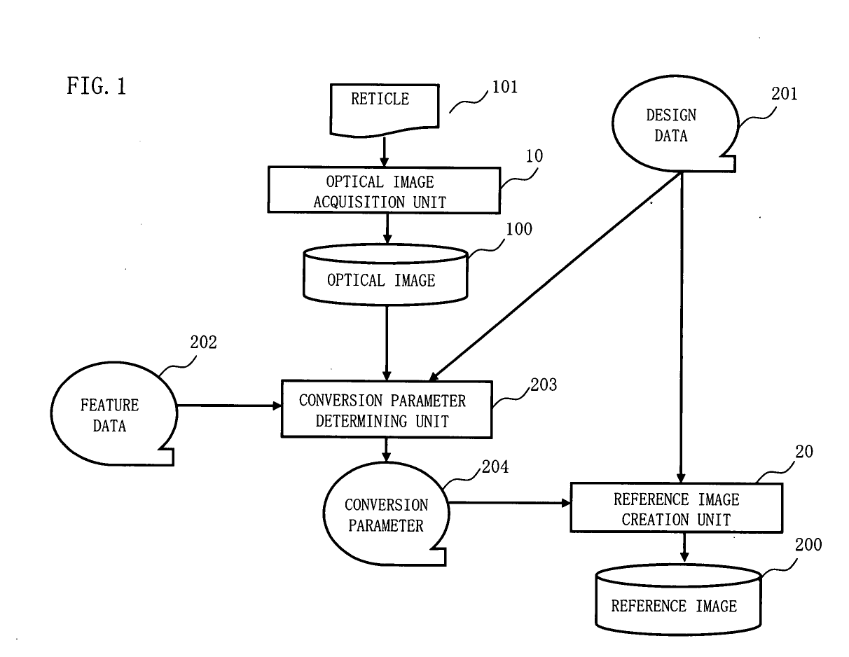

A reference image forming apparatus is to form a reference image similar to an optical image of a reticle. The reference image forming apparatus has, for example, as shown in FIG. 1, an optical image acquisition unit 10, a conversion parameter determining unit 203 and a reference image creation unit 20. The conversion parameter determining unit 203 forms conversion parameter 204 from an optical image 100 obtained by the optical image acquisition unit 10, feature data 202 representing pattern features of a reticle, and design data 201 of the image of the reticle. The reference image creation unit 20 causes the conversion parameter 204 obtained by the conversion parameter determining unit 203 to act on the design data 201 and performs arithmetic processing to form a reference image 200 serving as an image made similar to the optical image. The design data 201 used in this case is image data obtained by developing data in the expander 111. The conversion parameter determining unit 203 and the reference image creation unit 20 can be constituted by, for example, the expander 111 and the referencing unit 112 in FIG. 12. The expander 111 is to read design data of an image of a reticle from the magnetic tape device 115 through the central processing unit 110 to convert the design data into image data. The reference image creation unit 20 can be constituted by an electronic circuit, a program, or a combination thereof.

The feature data 202 used here is to designate a specific pattern of an image of a reticle. The feature data is identification data which is formed when an image of a reticle is designed, corresponds to a pattern position of the reticle, and designates a pattern. The feature data is, for example, expressed by an image in association with the image of the reticle and constituted by data of a pixel value. The feature data can give a weight to the pattern of the image of the reticle. The feature data indicates a pattern desired to be drawn at high precision, an assistant pattern, a dummy pattern, or the like. As a pattern used in the embodiment, a pattern having any shape may be used. For example, an independent pattern, a pattern obtained by combining independent patterns, a portion (part) of an independent pattern, or a portion (part) of a combined pattern may be used.

(Optical Image Acquisition Unit)

The optical image acquisition unit 10 acquires an optical image of the reticle 101. The reticle 101 serving as a sample to be inspected is placed on the XYθ table 102. The XYθ table 102 is controlled by motors 151, 152, and 150 of X, Y, and θ axes in accordance with a command from the table controller 114 such that the XYθ table 102 moves in a horizontal direction or a rotating direction. Light from the light source 103 is irradiated on a pattern formed on the reticle 101. Light transmitted through the reticle 101 is focused as an optical image on the photodiode array 105 through the magnifying optics system 104. An image fetched by the photodiode array 105 is processed by the sensor circuit 106, and serves as data of an optical image to be compared with a reference image.

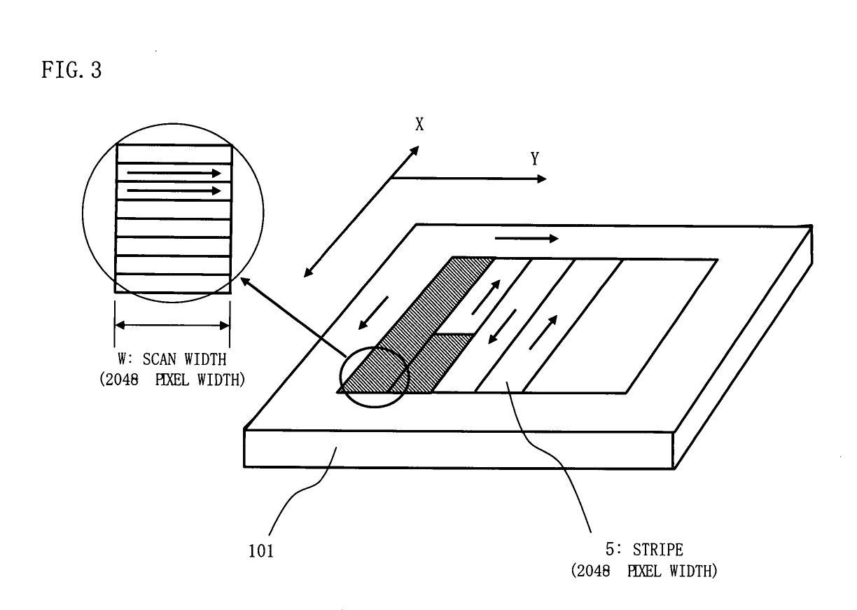

A procedure for acquiring an optical image will be described below with reference to FIG. 3. A region to be inspected on the reticle 101 is, as shown in FIG. 3, virtually divided into a plurality of strip-like inspection stripes 5 each having a scan width W in a Y direction. The divided inspection stripes 5 are continuously scanned. For this purpose, the XYθ table 102 moves in an X direction under the control of the table controller 114. In accordance with the movement, optical images of the inspection stripes 5 are acquired by the photodiode array 105. The photodiode array 105 continuously acquires the images each having a scan width W. After the photodiode array 105 acquires the image of the first inspection stripe 5, the photodiode array 105 continuously acquires the image of the second inspection stripe 5 in the scan width W by the same method as described above though in a direction opposing the scanning direction of the first inspection stripe 5. The image of the third inspection stripe 5 is acquired in a direction opposing the direction for acquiring the image of the second inspection stripe 5, i.e., in the direction for acquiring the image of the first inspection stripe 5. In this manner, the images are continuously acquired to shorten wasteful processing time. In this case, for example, the scan width W is made 2048 pixels.

The image of the pattern formed on the photodiode array 105 is photoelectrically converted by the photodiode array 105, and then A/D (analog/digital)-converted by the sensor circuit 106. The light source 103, the magnifying optics system 104, the photodiode array 105, and the sensor circuit 106 constitute a high-power inspection optical system.

The XYθ table 102 is driven by the table controller 114 under the control of the central processing unit 110. A moving position of the XYθ table 102 is measured by the laser-assisted length measurement system 122, and the resultant measured value is transmitted to the position measurement unit 107. The reticle 101 on the XYθ table 102 is carried from the autoloader 130 under the control of the autoloader controller 113. Measured pattern data of the inspection stripes 5 output from the sensor circuit 106 is transmitted to the referencing unit 112 and the comparator 108 of the conversion parameter determining unit 203 together with the data which represents a position of the reticle 101 on the XYθ table 102 and is output from the position measurement unit 107. The data of the optical image and the data of the reference image to be compared are cut into areas each having an appropriate pixel size. For example the data are cut into regions each having 512×512 pixels.

(Conversion Parameter Determining Unit)

The conversion parameter determining unit is to determine a conversion parameter. The conversion parameter acts on design data to convert the design data into an appropriate reference image. The conversion parameter also operates as a filter which acts on the design data to obtain an appropriate reference image. The conversion parameter is calculated by feature data according to the characteristics of the pattern of the reticle. The characteristic parameter is calculated according to the characteristics of the pattern such that a weight is given to an image position of the pattern of the reticle. The conversion parameter is calculated by, for example, Equation 1. In this equation, Iref(x) indicates a reference image, Idsn(x) indicates design data, and f(x) indicates a conversion parameter. In Equation 1, a convolution operation between the conversion parameter f(x) and the design data Idsn(x) is performed to calculate a reference image Iref(x). In this case, the reference image Iref(x) and the design data Idsn(x) are image data constituted by a grayscale such as a luminance in each pixel (x). The conversion parameter f(x) is also data having a value in each pixel. The conversion parameter may also be handled as a fixed parameter group independent of a position x.
Iref(x)=f(x) [symbol] Idsn(x)

The conversion parameter f(x) is calculated from the optical image and the design data of the reticle by using the feature data based on the characteristics of the pattern of the image of the reticle. More specifically, the conversion parameter f(x) is calculated such that a sum of values obtained by multiplying a difference between the optical image and the reference image by weights of the feature data is minimized. The conversion parameter f(x) is calculated by minimizing a sum Δ of Equation 2, for example. In this equation, Iscn(x) indicates an optical image, and w(x) indicates feature data which means a weight of a specific pattern. The optical image is image data constituted by a grayscale such as a luminance in each pixel (x).
Δ=Σ{w(x)×|Iscn(x)−Iref(x)|}

The feature data weights positions of pixels depending on the characteristics of the patterns of the reticle. In this manner, according to Equation 2, a total sum of pixels of the difference between the images of the reticle is calculated, and the conversion parameter is calculated such that the total sum is minimized. In this manner, the conversion parameter corresponding to the degrees of importance of the pixels of the pattern can be formed.

(Reference Image Forming Method)

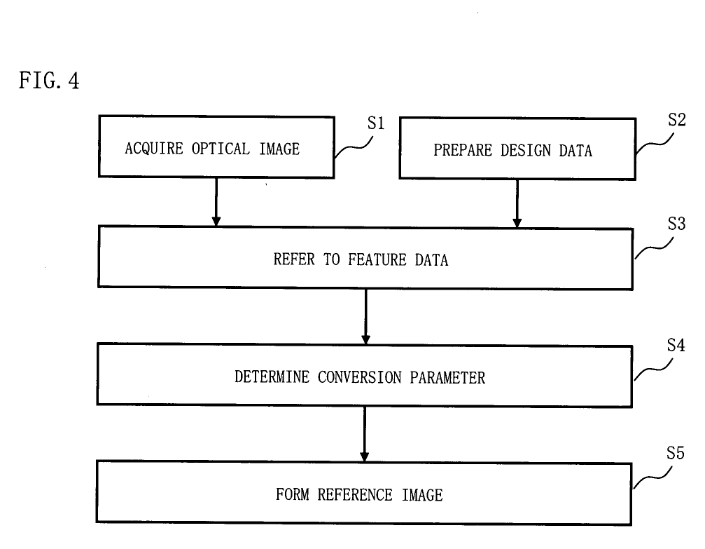

The reference image forming method is performed by steps as shown in FIG. 4. In step S1, an optical image drawn on a reticle is acquired. In step S2, design data is prepared to obtain a reference image of the image of the reticle. In step S3, feature data representing the pattern features of the image of the reticle is referred to. In step S4, a conversion parameter is calculated by using the feature data. In step S5, the conversion parameter is caused to act on design data to form a reference image. In step S5, more specifically, arithmetic processing between the conversion parameter and the design data is performed by using Equation 1 to form a reference image. In this manner, the feature data is used in formation of the reference image to weight patterns of the image of the reticle. In other words, a specific pattern is emphasized to appropriately form a reference image having higher precision.

(Pattern Inspecting Method)

The pattern inspecting method is a method which compares a reference image obtained by the reference image forming method by using feature data corresponding to a more specific pattern with an optical image of a reticle to inspect patterns of a reticle. As a result, pattern inspection of the reticle can be more appropriately and accurately performed.

(Inspected Reticle)

A reticle is drawn by a drawing device using design data. The formed reticle is inspected by a pattern inspection apparatus with respect to an optical image. In this case, pattern inspection is performed by comparing the optical image with the reference image. The reference image is calculated by performing arithmetic processing between a conversion parameter and the design data. The conversion parameter is calculated such that a sum of values obtained by multiplying a difference between the optical image and the reference image by weights of the feature data is minimized. In this manner, since a reference image obtained in consideration of the weights of the feature data is used in pattern inspection of the reticle, the reticle having a more accurate image can be obtained.

### First Embodiment

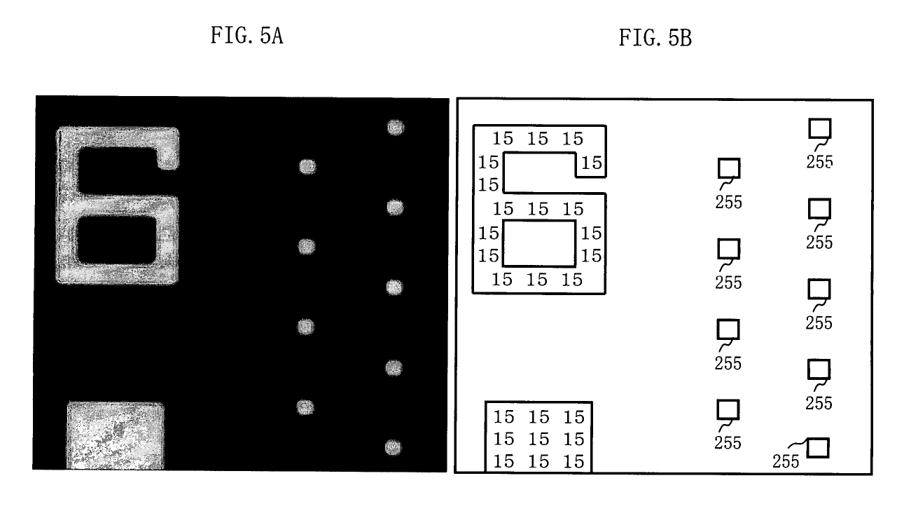

A portion of a specific pattern according to a first embodiment of the present invention is shown in FIG. 5A. Feature data corresponding to the portion is shown in FIG. 5B as image data. A white-dot-like hole on the right side of FIG. 5A, for example, a pattern of a contact hole, is a pattern having high drawing precision. Feature data in FIG. 5B corresponds to an image position of a pattern of a contact hole and indicates a value of 255. The feature data is expressed by an image and represented by a pixel value. In this example, the value of the feature data falls within the range of, e.g., 0 to 255, for example.

A white pattern on the left side of FIG. 5A is a pattern having a low drawing precision, for example, a dummy pattern. FIG. 5B corresponds to an image position of the dummy pattern and shows a value of 15. The weight w(x) is defined by dividing a value (pixel value) of feature data by 255 and a real number falling within 0≦w(x)≦1. The value of the weight w(x) is assigned to w(x) in Equation 2 to calculate a conversion parameter f(x). The conversion parameter f(x) is assigned to f(x) in Equation 1 to calculate a reference image. In this manner, feature data of a large pixel value is given to a specific pattern required to be formed at a high precision, and feature data of a small pixel value is given to a pattern not required to be formed at a high precision. The feature data are used to make it possible to obtain a reference image similar to the optical image with a focus on an important pattern portion of the reticle.

### Second Embodiment

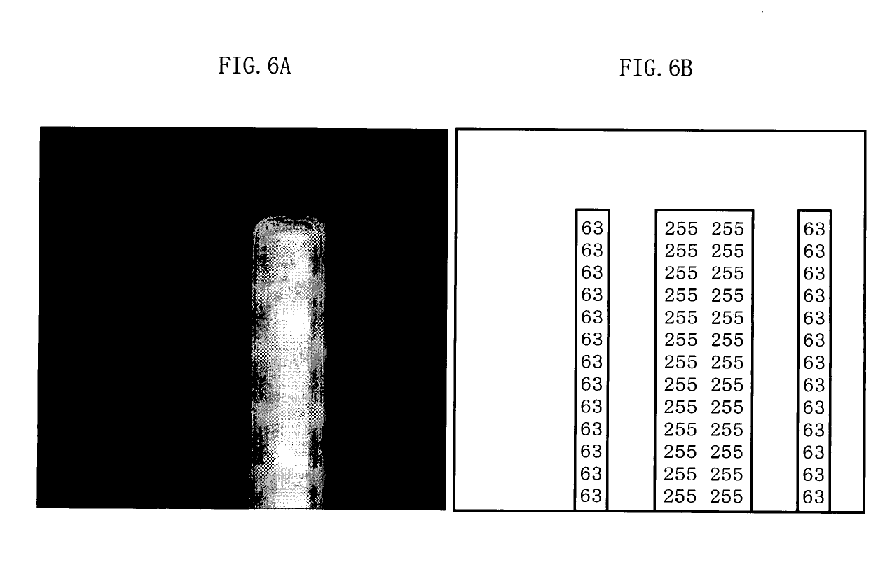

A specific pattern portion according to a second embodiment of the present invention is shown in FIG. 6A. Feature data corresponding to the pattern portion is shown in FIG. 6B as image data. A white wide-strip-shaped pattern is a pattern having a high drawing precision, and narrow-strip-shaped patterns on both the sides of the wide-strip-shaped pattern are patterns not required to be formed at a high precision, for example, an assistant pattern. Feature data of the pattern having the high drawing precision in FIG. 6A is shown as a value of 255. Feature data of the assistant pattern in FIG. 6A is shown as a value of 63. The feature data of the assistant pattern is larger than the dummy pattern in FIG. 5. In this manner, different degrees of importance can be given to different patterns by feature data, respectively. The weight of the feature data is calculated by dividing a pixel value of the assistant data by 255 as in the first embodiment.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reference image forming apparatus comprising:
an optical image acquisition unit which acquires an optical image of an object to be inspected;
a conversion parameter determining unit which uses feature data based on pattern features of the image of the object to be inspected to calculate a conversion parameter from the optical image and design data of the object to be inspected; and
a reference image creation unit which performs arithmetic processing to the conversion parameter and the design data to form a reference image.

2. The reference image forming apparatus according to claim 1, wherein
the feature data is a weight given to a pattern, and
the conversion parameter determining unit calculates a sum obtained by multiplying a difference between the optical image and the reference image by the weights of the feature data and determines a conversion parameter such that the sum is minimized.

3. A pattern inspection apparatus comprising:
an optical image acquisition unit which acquires an optical image of an object to be inspected;
a conversion parameter determining unit which uses feature data based on pattern features of the image of the object to be inspected to calculate a conversion parameter from the optical image and design data of the object to be inspected;
a reference image creation unit which performs arithmetic processing to the conversion parameter and the design data to form a reference image; and
a comparator unit which compares the optical image with the reference image.

4. The pattern inspection apparatus according to claim 3, wherein
the feature data is a weight given to a pattern, and
the conversion parameter determining unit calculates a sum obtained by multiplying a difference between the optical image and the reference image by the weights and determines a conversion parameter such that the sum is minimized.

5. A reference image forming method which forms a reference image similar to an optical image of an object to be inspected from design data of the object to be inspected, comprising:
using feature data representing pattern features in an image to calculate a conversion parameter from the optical image and the design data; and
performing arithmetic processing to the conversion parameter and the design data to form a reference image.

6. The reference image forming method according to claim 5, wherein
the feature data is a weight given to the pattern, and
a difference between the optical image and the reference image is multiplied by a weight to calculate a conversion parameter.

7. The reference image forming method according to claim 5, wherein
a weight of the feature data with respect to a pattern that requires a high drawing precision is increased.

8. The reference image forming method according to claim 5, wherein
a weight of the feature data with respect to an assistant pattern is decreased.

9. The reference image forming method according to claim 5, wherein
a weight of the feature data with respect to a dummy pattern is decreased.

10. A reticle which undergoes a pattern inspection which uses feature data representing pattern features of an image of the reticle to calculate a conversion parameter from an optical image and design data, performs arithmetic processing to the conversion parameter and the design data to form a reference image, and compares the optical image with the reference image.

11. The reticle according to claim 10, wherein
the feature data is a weight given to the pattern, and
an conversion parameter is calculated such that a sum obtained by multiplying a difference between the optical image and the reference image by the weights of the feature data is minimized.
